(19) United States
(12) Patent Application Publication
(10) Pub. No.: US 2004/0249992 A1
(43) Pub. Date: Dec. 9, 2004

(54) Methods and apparatus to provide environment-based instruction selection

(76) Inventors: Eshwari P. Komarla, Olympia, WA (US); Vincent J. Zimmer, Federal Way, WA (US); Mallik Bulusu, Olympia, WA (US); Michael A. Rothman, Gig Harbor, WA (US)

Correspondence Address: GROSSMAN & FLIGHT LLC, Suite 4220, 20 North Wacker Drive, Chicago, IL, 60606-6357, US

(21) Appl. No.: 10/427,791

(22) Filed: Apr. 30, 2003

(51) Int. Cl. G06F 3/00

(52) U.S. Cl. 710/8

(57) ABSTRACT

Methods and apparatus to provide environment-based instruction selection are disclosed. In one example, a disclosed method may include locating a storage device storing a plurality of instruction sets, determining which sets of the plurality of instruction sets are compatible based on an environmental factor associated with a processor, copying the compatible instruction sets into a memory and executing the compatible instruction sets.

### TECHNICAL FIELD

The present disclosure is directed generally to computer systems and, more particularly, to methods and apparatus to provide environment-based instruction selection.

### BACKGROUND

Computing devices, such as personal computers, servers, etc. include a main circuit board (i.e., a motherboard) having a main processor to which a number of different peripheral devices (e.g., display drivers, disk controllers, network cards, etc.) may be connected to provide enhanced functionality to the motherboard. As will be readily appreciated, the main processor may be arranged according to one of any number of different processor architectures, such as an Intel architecture, a PowerPC architecture, a SPARC architecture, etc.

While a motherboard includes rudimentary computing functionality and some on-board devices (e.g., on-board network interfaces, etc.), motherboards rely on peripherals to, for example, control a compact disk (CD) drive, etc. The peripherals may be connected to the motherboard via a number of different interfaces including peripheral component interconnect (PCI) slots in the motherboard, universal serial bus (USB) connections, etc.

Usually, each peripheral connected to the motherboard includes memory (e.g., an option read only memory (ROM)) containing instructions that are pre-programmed (e.g., burned) therein. The instructions may compose procedures to be executed by the peripheral, settings for the peripheral or instructions to be exported to the main processor from the peripheral. As will be readily appreciated, there is a need to operate a peripheral with a number of different architectures (e.g., Intel, PowerPC, SPARC, etc.) For example, a particular display adapter peripheral may be used in conjunction with both a personal computer (PC) having an Intel architecture and a workstation having a SPARC architecture because both the PC and the workstation use display adapter peripherals to present information to users. However, each architecture requires the peripheral to have separate sets of instructions to interface the peripheral to each architecture.

In addition to the need to vary the option ROMs to accommodate different architectures, peripheral manufacturers often vary the contents of the option ROM based on the domain (e.g., laptop, desktop, workstation, server, etc.) of the system in which the peripheral is to be used. For example, a peripheral to be used with a server domain may be outfitted with reliability, availability and similarity (RAS) functionality, whereas a peripheral to be used with a desktop or laptop domain need not include RAS functionality. Furthermore, adapter cards may be used in a number of different markets, such as the United States, India, China, etc., having different native languages and, therefore, having different option ROMs supporting the native languages.

To accommodate the diverse domains, platforms and languages (i.e., the general environment) in which peripherals may be used, peripheral manufacturers maintain different inventories of the same peripheral device. Typically the only differences between the different inventories are the option ROMs on the devices. For example, a particular display adapter manufacturer may have a standard circuit board on which a number of components are disposed. In that case, the option ROMs placed on the circuit boards define whether the display adapters are adapted to operate with Intel, SPARC or PowerPC architectures. The option ROM functionality may further be segmented based on the native languages of the markets in which the cards are to be sold and on the domains in which the adapter cards are to be used. For example, display drivers having a native Japanese language for use on servers having an Intel architecture may be one stock keeping unit (SKU), while display drivers having a native Japanese language for use with PowerPC architecture desktops may be another SKU.

As will be readily appreciated by those having ordinary skill in the art, the requirement for peripheral manufacturers to produce and maintain stocks of peripheral devices having different SKUs that are segmented by architecture, domain and language is costly and burdensome. Additionally, instructions and settings are usually burned into option ROMs, thereby making it impossible to change the settings and instructions once the peripherals are shipped.

### BRIEF DESCRIPTION OF THE DRAWINGS

FIG. 1 is a block diagram of an example environment-based instruction selection system.

FIG. 2 is a block diagram of an example computing system on which the environment-based instruction selection system of FIG. 1 may be implemented.

FIG. 3 is a flow diagram of an example basic input/output system (BIOS) boot process that may be carried out by the computing system of FIG. 2.

FIG. 4 is a flow diagram of a second example BIOS boot process that may be carried out by the computing system of FIG. 2.

### DETAILED DESCRIPTION

The following describes example methods, apparatus and articles of manufacture that provide environment-based instruction selection. While the following disclosure describes systems implemented using software or firmware executed by hardware, those having ordinary skill in the art will readily recognize that the disclosed systems could be implemented exclusively in hardware through the use of one or more custom circuits, such as, for example, application-specific integrated circuits (ASICs) or any other suitable combination of hardware and/or software.

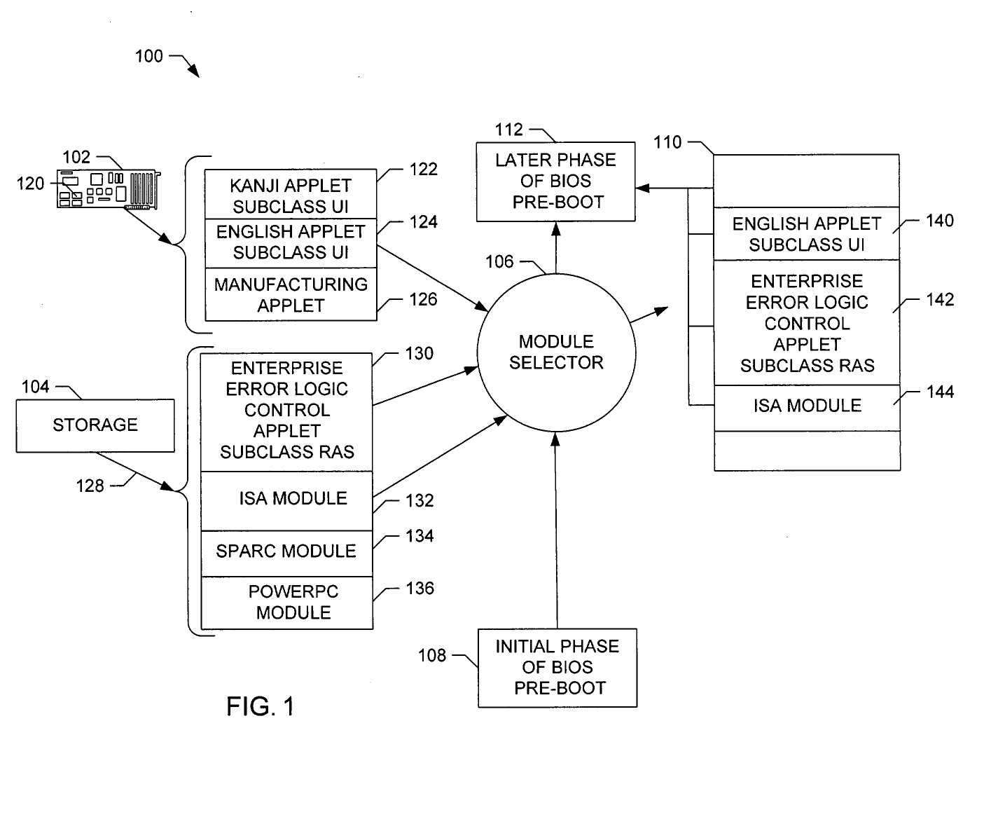

As shown in FIG. 1, an example environment-based instruction selection system 100 includes one or more peripheral(s) 102, one or more storage device(s) 104, a module selector 106, an initial phase of BIOS pre-boot 108, a memory device 110 and a later phase of BIOS pre-boot 112.

The peripheral 102 may be any computer peripheral such as, for example, a display driver, a disk controller, etc. The peripheral 102 may include a memory device 120 (e.g., an option ROM, flash memory, electrically erasable programmable read only memory (EEPROM), etc.), in which one or more instruction sets, or applets, may be stored. For example, as shown in FIG. 1, the memory device 120 may store a number of applets that are sub-classed under the class of the peripheral 102. For example, the memory device 120 may store a Kanji applet 122, an English applet 124 and a manufacturing applet 126. In such an arrangement, the Kanji applet 122 and the English applet 124 are sub-classed as user interface (UI) applets because they are used to render Kanji or English characters in a UI that is used during the configuration of the peripheral 102. In practice, only one of the Kanji applet 122 and the English applet 124 is used at one time.

The manufacturing applet 126 may be used during the factory testing of the peripheral 102. For example, the manufacturing applet 126 may include instructions invoked by factory test equipment when the peripheral 102 is factory tested (i.e., before the peripheral 102 is shipped to retailers or consumers).

The storage device 104 may be any suitable magnetic or optical media or device or drive that may store a number of applets and/or modules. The storage device 104 may be local to the remaining components of the system 100 or may be remote therefrom. Alternatively, the storage device 104 may be networked to the remaining components of the system via a network connection 128. For example, the storage device 104 may be connected to the remaining system components via a local area network (LAN), a wide area network (WAN), the Internet, etc. In one particular example, the storage device 104 may be maintained by the vendor of the peripheral 102. Additionally, although shown as a single storage device 104 in FIG. 1, the storage device 104 may be implemented by numerous storage devices that may be local or networked together.

As shown in FIG. 1, in addition to the applets 122-126 the storage device 104 may store an enterprise error logic control applet 130 having a sub-class of redundancy, availability and similarity (RAS). The enterprise error logic control applet 130 is an applet that would be used if the peripheral 102 is coupled to a server. Conversely, if the peripheral 102 were not coupled to a server and were instead coupled to a desktop PC or a laptop PC, the enterprise error logic control applet 130 would not be needed.

The storage device 104 also stores a number of modules that are segmented according to system architecture. For example, an instruction set architecture (ISA) module 132, a SPARC module 134 and a PowerPC module 136 may be stored within the storage device 104. As will be readily appreciated, the modules 132-136 will be used exclusively of one another based on the processor architecture or processing platform to which the storage device 104 is coupled. For example, the ISA module 132 is useful only if the storage device 104 is coupled to an Intel-type processor architecture and the SPARC and PowerPC modules 134, 136 are only useful when the storage device 104 is coupled to a Sun-type processor architecture or a Motorola PowerPC-type architecture, respectively. As with the applets, the modules may be implemented using instruction sets.

The applets 122-126, 130 and modules 132-136 may include a vendor identifier (ID) and a device ID, which could be extracted and used to generate an index of applets and/or modules. Such an arrangement would enable applets and/or modules to be stored off-line, wherein a host-protected addressing (HPA) arrangement could be used to store and retrieve applets and/or modules. In the alternative, an ISA architecture, such as an IA32 BIOS ROM, an IEEE 1275 OpenFirmware FCODE and/or an Extensible Firmware Interface (EFI), could be used to sub-class modules and/or applets to support domain and platform-specific logic to selectively execute some or all applets and/or modules.

Of course, as will be readily appreciated by those having ordinary skill in the art, more applets and/or modules (i.e., instruction sets) than those shown in FIG. 1 may be stored in the peripheral 102 and/or the storage device 104. For example, the peripheral 102 and/or the storage device 104 may store user interface applets for different sets of characters other than English and Kanji. Additionally, the peripheral 102 and/or the storage device 104 may store applets or modules that are useful with different processor architectures (i.e., platforms) or with different domains (e.g., servers, laptops, desktops, etc).

As disclosed in detail below, the environment-based instruction selection system 100, which may be implemented by instructions stored and executed by a BIOS, examines the state of the BIOS and based on the BIOS selects applets and/or modules that are useful based on the processor architecture (i.e., the platform), and the domain in which the system is implemented. For example, the system 100 will select and execute language-based applets (e.g., 122 and/or 124), domain-based applets (e.g., 130) and/or platform-based modules (e.g., 132-136) based on settings within the BIOS.

The module selector 106, the initial phase of BIOS pre-boot 108 and the later phase of BIOS pre-boot 112 may all be implemented using BIOS pre-boot instructions. Such instructions may be stored in memory as firmware that is executed by a processor before an operating system (OS) is loaded by the processor. In general, the module selector 106 receives information from the initial phase of BIOS pre-boot 108 and selectively loads applets (e.g., the applets 122-126 and 130) and/or modules (e.g., the modules 132-136) into the memory device 110 based thereon. The selection of instructions (i.e., the applets and/or modules) by the module selector 106 is based on settings within the BIOS, including the native language, the platform type, the domain, etc. After applets and/or modules are loaded into the memory device 110, the later phase of BIOS pre-boot 112 executes the applets and/or modules to impart their functionality into a processor on which the BIOS is being executed.

In operation, the initial phase of BIOS pre-boot 108 reads firmware settings specifying various aspects of the operational environment in which the BIOS is operating. The environment may be specified by, for example, a native language, an operating platform or processor architecture and/or a domain in which the processor and BIOS are operating. For example, the environment may be specified to be a native language using English alphabetical characters, wherein the BIOS operates on a processor having an ISA architecture implemented as a server.

The information from the initial phase of BIOS pre-boot 108 passes to the module selector 106, which also receives, or has access to, the applets 122-126, 130 and/or modules 132-136. The module selector 106 selects certain ones of the applets 122-126, 130 and the modules 132-136 based on the environment in which the BIOS is operating. The selection may be based on applet sub-classes, or the like and may be performed using a look-up table, a query or any other arrangement. For example, with respect to an English language BIOS version operating on an Intel-type architecture in a server, the module selector 106 selects the English applet 124, the enterprise error logic control applet 130 and the ISA module 132. The selected applets (e.g., the applets 124, 130) and modules (e.g., the module 132) are mirrored, or copied, into the memory device 110.

The memory device 110 may be, for example, system memory, such as, RAM, static RAM (SRAM), dynamic RAM (DRAM) or the like, from which instructions are retrieved and executed by a processor. In the alternative, the memory device 110 may be implemented using any other memory device. In addition to other instructions or data, the memory device 110 may store copies of applets and modules selected by the module selector 106. For example, as shown in FIG. 1, the memory device 110 may store a copy of an English applet 120, a copy of an enterprise error logic control applet 122 and may also store a copy of an ISA module 124.

After the selected applets and modules are written into the memory device 110, the later phase of BIOS pre-boot 112 is started, which results in the execution of the applets and modules mirrored into the memory device 110. For example, with reference to FIG. 1, the mirror of the English applet 124 (reference numeral 140), the copy of the enterprise error logic control applet 130 (reference numeral 142) and the copy of the ISA module 132 (reference numeral 144) may be executed by the later phase of BIOS pre-boot 112. The execution of the applets 140, 142 and the module 144 places the processor executing the applets and the module in a state compatible with the language preference, platform and domain specified by the BIOS.

As will be readily appreciated by those having ordinary skill in the art, the foregoing system enables hardware vendors to ship peripherals with minimal hard-coded instructions because applets or modules associated with the peripheral may be provided by a storage media, such as a compact disk (CD), a digital versatile disk (DVD), a floppy disk, a hard drive and the like. Additionally, the applets or modules may be provided via storage media located remote from the system in which the peripheral is installed. For example, a peripheral may be shipped with a model number and a uniform resource locator (URL) hard coded therein. Upon installation of the peripheral and the application of system power, the initial phase of BIOS pre-boot 108 and the module selector 106 may access the URL to make applets and/or modules related to the peripheral available. The module selector 106 may then selectively load certain ones of the applets and/or modules into a memory out of which the applets and/or modules may be executed.

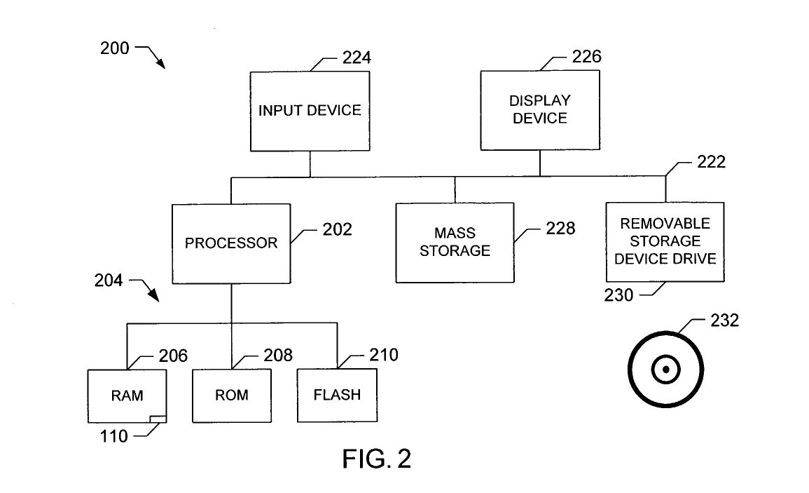

Turning now to FIG. 2, an example processor system 200 on which the disclosed processes may be executed includes a processor 202 having associated memory 204, which may be implemented using, for example, a random access memory (RAM) 206 (in which the memory device 110 of FIG. 1 may be implemented), a read only memory (ROM) 208 and/or a flash memory 210. The processor 202 is coupled to an interface, such as a bus 222 to which other components may be interfaced. In the illustrated example, the components interfaced to the bus 222 include an input device 224; a display device 226 (which may be a peripheral, such as the peripheral 102 of FIG. 1); a mass storage device 228 (which may correspond to the storage device 104 of FIG. 1) and a removable storage device drive 230. The removable storage device drive 230 may include associated removable storage media 232, such as magnetic or optical media. As noted previously, the removable storage device drive 230 and the removable storage media 232 may be used in the implementation of the storage device 104.

The example processor system 200 may be, for example, a conventional desktop personal computer, a notebook computer, a workstation or any other computing device. The processor 202 may be any type of processing unit, such as a microprocessor from the Intel® Pentium® family of microprocessors, the Intel® Itanium® family of microprocessors, and/or the Intel XScale® family of processors. The memories 206, 208 and 210 that are coupled to the processor 202 may be any suitable memory devices and may be sized to fit the storage demands of the system 200. In particular, the flash memory 210 may be a non-volatile memory that is accessed and erased on a block-by-block basis.

The input device 224 may be implemented using a keyboard, a mouse, a touch screen, a track pad or any other device that enables a user to provide information to the processor 202. Alternatively or additionally, the input device 224 may be a network connection from which data may be passed to the processor 202.

The display device 226 may be, for example, a liquid crystal display (LCD) monitor, a cathode ray tube (CRT) monitor or any other suitable device that acts as an interface between the processor 202 and a user. The display device 226 as pictured in FIG. 2 includes a peripheral device required to interface a display screen to the processor 202.

The mass storage device 228 may be, for example, a conventional hard drive or any other magnetic or optical media that is readable by the processor 202.

The removable storage device drive 230 may, for example, be an optical drive, such as a compact disk-recordable (CD-R) drive, a compact disk-rewritable (CD-RW) drive, a (DVD) drive or any other optical drive. It may alternatively be, for example, a magnetic media drive. The removable storage media 232 is complimentary to the removable storage device drive 230, inasmuch as the media 232 is selected to operate with the drive 230. For example, if the removable storage device drive 230 is an optical drive, the removable storage media 232 may be a CD-R disk, a CD-RW disk, a DVD disk or any other suitable optical disk. On the other hand, if the removable storage device drive 230 is a magnetic media device, the removable storage media 232 may be, for example, a diskette or any other suitable magnetic storage media.

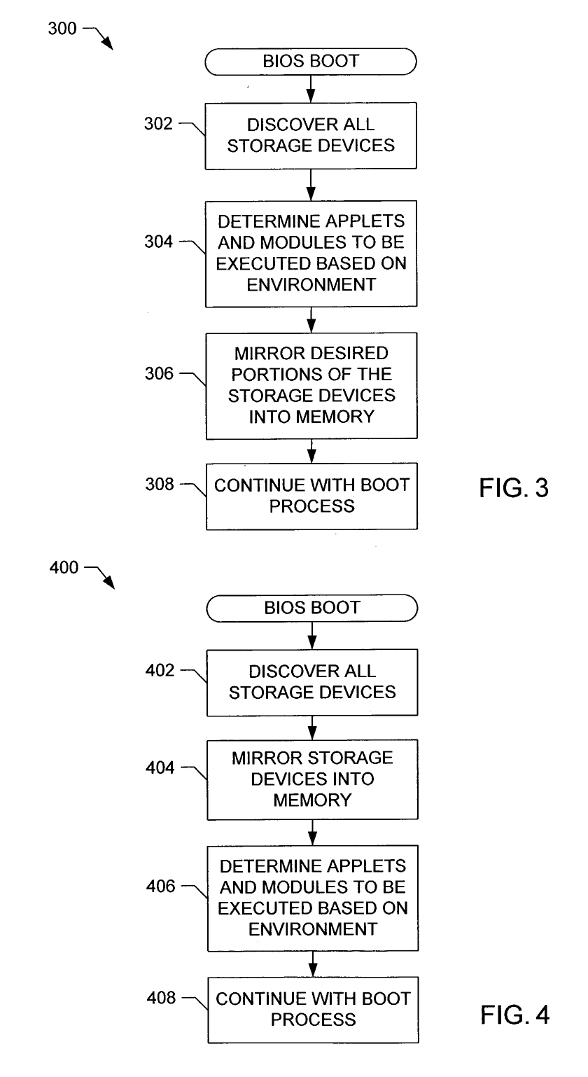

As shown in FIGS. 3 and 4, BIOS boot processes 300 and 400, which may be executed on the system 200 described in conjunction with FIG. 2, may be represented by flow diagrams including a number of blocks. The functionality represented by the blocks of FIGS. 3 and 4 may be implemented using instructions that may, for example, be stored in the memory 204 and executed by the processor 202. In particular, if the instructions are implemented in firmware, such instructions may be stored in ROM 208. While the blocks of the flow diagrams of FIGS. 3 and 4 are shown in a particular sequence, those having ordinary skill in the art will readily recognize that the functions associated with such blocks may be implemented in other sequences than that shown in FIGS. 3 and 4.

The BIOS boot process 300 begins execution by discovering all storage devices including applets and/or modules (block 302). The results of the discovery process may be a list of applets and/or modules, a list of locations of the applets and/or modules and sub-classes into which the applets and/or modules fall. For example, with reference to FIG. 1, the memory device 120 and the storage device 104 may be discovered, along with the applets and/or modules stored thereon. As noted previously, the storage devices may be local to the system 100 or may be located remotely therefrom. For example, storage devices may be remotely located at network locations found on websites, etc.

After the storage devices and associated applets and modules have been discovered (block 302), a list of applets and modules to be executed is generated based on the environment in which the process 300 is operating (block 304). For example, certain applets and/or modules may be selected based on environmental indicators stored in firmware, such environmental indicators may include system architecture (e.g., Intel-based, PowerPC-based, SPARC-based, etc.), language preference (e.g., English, Indian, Japanese, etc.) or domain (e.g., server, desktop, laptop, etc.) In one particular example, with reference to FIG. 1, if the process 300 is operating on an Intel-based architecture in a server operating with a native English language, the applets 124, 130 and the module 132 are selected to be executed.

After the applets and/or modules for execution are selected (block 304), the portion(s) of the storage device(s) containing the selected applets and/or modules are copied into memory (block 306). The memory may be, for example, system memory 204 of FIG. 2. In the alternative, the selected applets and/or modules may be mirrored into a memory that is a portion of the mass storage device 228 of FIG. 2 or could be mirrored onto the removable storage media 232.

After the applets and/or modules are mirrored into memory (block 306), the BIOS boot process 300 may continue with the boot process (block 308). As one example, the boot process may continue by executing the applets and/or modules mirrored into the memory. The execution of such modules imparts the functionality associated therewith to a processor that is executing the process 300.

The process 300 of FIG. 3 finds modules and/or applets and selectively mirrors them into memory for later execution. In contrast, generally, the BIOS boot process 400 of FIG. 4 mirrors all discovered applets and/or modules into a memory and selectively executes portions of the memory based on the environment in which the process 400 is operating.

Turning to FIG. 4 in more detail, the BIOS boot process 400 begins by discovering all storage devices that include applets and/or modules (block 402) and mirroring all such storage devices into memory (block 404). After the applets and/or modules are mirrored into memory (block 404), the applets and/or modules to be executed are determined based on the environment in which the process 400 is being executed (block 406). For example, if the process 400 is operating on a server, modules and/or applets associated with a domain of server are selected for execution. Further determination as to the desirability of executing the applets and/or modules mirrored into memory may include making native language determinations or platform determinations. After the applets and/or modules are selected for execution (block 406), the process 400 continues its boot process (block 408), which may include the execution of modules selected by the process 400 at block 406.

Although certain apparatus constructed in accordance with the teachings of the invention have been described herein, the scope of coverage of this patent is not limited thereto. On the contrary, this patent covers every apparatus, method and article of manufacture fairly falling within the scope of the appended claims either literally or under the doctrine of equivalents.

What is claimed is:

1. A method of providing environment-based instruction selection, the method comprising:
locating a storage device having a plurality of instruction sets stored thereon;
determining which sets of the plurality of instruction sets are compatible with an environmental factor associated with a processor;
copying at least a portion of the compatible instruction sets into a memory; and
executing the at least a portion of the compatible instruction sets.

2. A method as defined by claim 1, wherein the environmental factor includes one of a domain specification and a platform specification.

3. A method as defined by claim 2, wherein the domain specification comprises one of a server, a desktop computer and a laptop computer.

4. A method as defined by claim 2, wherein the platform specification comprises one of an Intel-based architecture, a PowerPC-based architecture and a SPARC-based architecture.

5. A method as defined by claim 1, wherein the environmental factor is represented by information stored in a basic input/output system.

6. A method as defined by claim 1, wherein the environmental factor comprises a native language.

7. A method as defined by claim 1, wherein the storage device comprises a networked storage device.

8. A method as defined by claim 1, wherein the storage device comprises a hard disk drive.

9. A method as defined by claim 1, wherein each instruction set of the plurality of instruction sets comprises one of an applet and a module.

10. A method of providing environment-based instruction selection, the method comprising:
locating a storage device having a plurality of instruction sets stored thereon;
copying the plurality of instruction sets into a memory;
determining which sets of the plurality of instruction sets are compatible with an environmental factor associated with a processor; and
executing the compatible instruction sets.

11. A method as defined by claim 10, wherein the environmental factor includes one of a domain specification and a platform specification.

12. A method as defined by claim 11, wherein the domain specification comprises one of a server, a desktop computer and a laptop computer.

13. A method as defined by claim 11, wherein the platform specification comprises one of an Intel-based architecture, a PowerPC-based architecture and a SPARC-based architecture.

14. A method as defined by claim 10, wherein the environmental factor is represented by information stored in a basic input/output system.

15. A method as defined by claim 10, wherein the environmental factor comprises a native language.

16. A method as defined by claim 10, wherein each instruction set of the plurality of instruction sets comprises one of an applet and a module.

17. An article of manufacture comprising a machine-accessible medium having a plurality of machine accessible instructions that, when executed, cause a machine to:
locate a storage device having a plurality of instruction sets stored thereon;
determine which sets of the plurality of instruction sets are compatible with an environmental factor associated with a processor;
copy the compatible instruction sets into a memory; and
execute the compatible instruction sets.

18. A machine-accessible medium as defined by claim 17, wherein the environmental factor includes one of a domain specification and a platform specification.

19. A machine-accessible medium as defined by claim 18, wherein the domain specification comprises one of a server, a desktop computer and a laptop computer.

20. A machine-accessible medium as defined by claim 18, wherein the platform specification comprises one of an Intel-based architecture, a PowerPC-based architecture and a SPARC-based architecture.

21. A machine-accessible medium as defined by claim 17, wherein the environmental factor is represented by information stored in a basic input/output system.

22. A machine-accessible medium as defined by claim 17, wherein the environmental factor comprises a native language.

23. A machine-accessible medium as defined by claim 17, wherein the storage device comprises a networked storage device.

24. A machine-accessible medium as defined by claim 17, wherein the storage device comprises a hard disk drive.

25. A machine-accessible medium as defined by claim 17, wherein each instruction set of the plurality of instruction sets comprises one of an applet and a module.

26. A system comprising:
a system memory;
a storage device storing a plurality of instruction sets;
an initial phase of basic input/output system (BIOS) pre-boot storing environmental information;
a module selector coupled to the initial phase of BIOS pre-boot, to the system memory and to the storage device, wherein the module selector is configured to copy ones of the plurality of instruction sets into the system memory based on the environmental information; and
a later phase of BIOS pre-boot configured to execute the ones of the plurality of instruction sets in the system memory.

27. A system as defined by claim 26, wherein the environmental information includes one of a domain specification and a platform specification.

28. A system as defined by claim 27, wherein the domain specification comprises one of a server, a desktop computer and a laptop computer.

29. A system as defined by claim 27, wherein the platform specification comprises one of an Intel-based architecture, a PowerPC-based architecture and a SPARC-based architecture.

30. A system as defined by claim 27, wherein the environmental information is represented by information stored in a basic input/output system.

31. A system as defined by claim 27, wherein the environmental information comprises a native language.

32. A system as defined by claim 27, wherein the storage device comprises a networked storage device.

33. A system as defined by claim 27, wherein the storage device comprises a hard disk drive.

34. A system as defined by claim 27, wherein each instruction set of the plurality of instruction sets comprises one of an applet and a module.

35. An system comprising:
a processor;
a read only memory (ROM) device coupled to the processor; and
instructions stored on the ROM device that, when executed cause the processor to:
locate a storage device having a plurality of instruction sets stored thereon;
determine which sets of the plurality of instruction sets are compatible with the system based on an environmental factor associated with a processor;
copy the compatible instruction sets into a memory; and
execute the compatible instruction sets.

36. A system as defined by claim 35, wherein the environmental information includes one of a domain specification and a platform specification.

37. A system as defined by claim 36, wherein the domain specification comprises one of a server, a desktop computer and a laptop computer.

38. A system as defined by claim 36, wherein the platform specification comprises one of an Intel-based architecture, a PowerPC-based architecture and a SPARC-based architecture.
